(19) United States
(12) Patent Application Publication
(10) Pub. No.: US 2026/0359216 A1
(43) Pub. Date: Nov. 12, 2026

(54) GARBAGE COLLECTION METHOD AND DEVICE FOR HOST SIDE AND SOLID STATE DRIVE, STORAGE MEDIUM, ELECTRONIC APPARATUS, AND PROGRAM PRODUCT

(71) Applicant: Samsung Electronics Co., Ltd., Suwon-si (KR)

(72) Inventors: Jing XIA, Suwon-si (KR); Kun ZHANG, Suwon-si (KR); Peng YUN, Suwon-si (KR); Hui QI, Suwon-si (KR)

(73) Assignee: Samsung Electronics Co., Ltd., Suwon-si (KR)

(21) Appl. No.: 19/338,700

(22) Filed: Sep. 24, 2025

(30) Foreign Application Priority Data
May 9, 2025 (CN) 202510599738.2

(51) Int. Cl. G06F 12/02

(52) U.S. Cl. CPC G06F 12/0246; G06F 2212/7205

(57) ABSTRACT

A garbage collection method and device for a host side and a solid drive, a storage medium, an electronic apparatus, and a program product are disclosed. The garbage collection method for a host side including obtaining, for each of target objects in a solid state drive connected to the host side, lifetimes of other objects related to each of the target objects in the solid state drive as historical lifetimes of each of the target objects, the target objects include at least one of a reclaim unit object or a data file object, the reclaim unit object being a physical storage unit configured to store the data file object in the solid state drive; counting the historical lifetimes of each of the target objects to obtain a reference lifetime of each of the target objects; and performing garbage collection based on reference lifetimes of the target objects.

### CROSS-REFERENCE TO RELATED APPLICATION

This application is based on and claims priority under 35 U.S.C. § 119 to Chinese Patent Application No. 202510599738.2, filed on May 9, 2025, in the Chinese Intellectual Property Office, the disclosure of which is incorporated by reference herein in its entirety.

### TECHNICAL FIELD

The present disclosure relates to the technical field for solid state drives. More specifically, the present disclosure relates to garbage collection methods and devices for a host side and a solid state drive, a storage medium, an electronic apparatus, and a program product.

### BACKGROUND

Flexible Data Placement (FDP) is a host data placement technology (TP4146) in industry for reducing a write amplification factor (WAF) in a solid state drive (SSD). It may allow for the host to segregate data with similar lifetimes and place them in the same media stream to reduce garbage collection (GC).

A Log-Structured Merge Tree (LSM-Tree) is a level-based data structure and may be widely used in many databases with Key-Value (KV) storage. The Log-Structured Merge Tree may use an append-only write structure to reduce random write operations on a storage device, which may improve write efficiency, however the append-only write structure may also cause a write amplification effect.

### SUMMARY

Some example embodiments of the present disclosure are to provide a garbage collection method and device for a host side and a solid state drive, a storage medium, an electronic apparatus, and a program product to at least improve garbage collection efficiency.

According to some example embodiments of the present disclosure, there is provided a garbage collection method for a host side including obtaining, for each of target objects in a solid state drive connected to the host side, lifetimes of other objects related to each of the target objects in the solid state drive as historical lifetimes of each of the target objects, the target objects include at least one of a reclaim unit object or a data file object, the reclaim unit object being a physical storage unit configured to store the data file object in the solid state drive; counting the historical lifetimes of each of the target objects to obtain a reference lifetime of each of the target objects; and performing garbage collection based on reference lifetimes of the target objects.

In some example embodiments, the obtaining, for each of the target objects in the solid state drive connected to the host side, the lifetimes of the other objects related to each of the target objects in the solid state drive as the historical lifetimes of each of the target objects includes based on the target object including the reclaim unit, using a reclaim unit handle pointing to the target object as a target reclaim unit handle, and obtaining lifetimes of a plurality of historical reclaim units to which the target reclaim unit handle pointed as the historical lifetimes of the target object; and based on the target object including the data file, using a file level in which the target object is located as a target file level, and obtaining lifetimes of a plurality of historical data files that existed in the target file level as the historical lifetimes of the target object.

In some example embodiments, the obtaining the lifetimes of the plurality of historical reclaim units to which the target reclaim unit handle pointed as the historical lifetimes of the target object includes obtaining the lifetimes of the plurality of historical reclaim units to which the target reclaim unit handle pointed as historical lifetimes of all of the target objects to which the target reclaim unit handle points, and the obtaining the lifetimes of the plurality of historical data files that existed in the target file level as the historical lifetimes of the target object includes obtaining the lifetimes of the plurality of historical data files that existed in the target file level as historical lifetimes of all of the target objects in the target file level.

In some example embodiments, the counting the historical lifetimes of each of the target objects to obtain the reference lifetime of each of the target objects includes counting a value range of the historical lifetimes of each of the target objects; and determining a specified quartile of the value range as the reference lifetime of each of the target objects.

In some example embodiments, the historical lifetimes are continuously updated over time, and the counting the historical lifetimes of each of the target objects to obtain the reference lifetime of each of the target objects includes counting the historical lifetimes of each of the target objects to obtain the reference lifetime of each of the target objects based on a determination that a workload of the solid state drive has changed, at a cycle.

In some example embodiments, the performing garbage collection based on the reference lifetimes of the target objects includes transmitting the reference lifetime of the reclaim unit object of the target objects to the solid state drive to configure the reclaim unit object of the target objects as not to participate in the garbage collection until the reference lifetime corresponding to the reclaim unit object expires.

In some example embodiments, the garbage collection method further includes gathering object information of each of objects in the solid state drive belonging to categories that are identical to those of the target objects, wherein the object information includes start-time life, lifetime, and a storage relationship, wherein the start-life-time of the reclaim unit object is a time the reclaim unit object is assigned to be used for writing the data file object, wherein the storage relationship of the reclaim unit object includes the data file object written into the reclaim unit object, the start-life-time of the data file object is a creation time of the data file object, the storage relationship of the data file object includes the reclaim unit object into which the data file object is written.

In some example embodiments, the performing garbage collection based on the reference lifetimes of the target objects includes determining, for sets of data file objects on which the garbage collection is to be performed, a factor of each of the sets of data file objects according to the object information and the reference lifetimes involved in each of the sets of the data file objects, wherein each of the sets of the data file objects includes a plurality of data file objects that are to be simultaneously reclaimed, and wherein the factor is based on a performance gain resulting from reclaiming the each of the sets of the data file objects; determining a reclaiming order of the sets of data file objects according to the factors of the sets of data file objects; and performing the garbage collection on the sets of data file objects according to the reclaiming order.

In some example embodiments, wherein the factor includes at least one of a life factor of the data file object, a life factor of the reclaim unit object, a failure rate of the reclaim unit object, or a file overlapping rate of the reclaim unit object, the life factor of the data file object is determined by comparing survival duration with the reference lifetime of the data file object, the life factor of the reclaim unit object is determined by comparing usage duration with the reference lifetime of the reclaim unit object, the failure rate of the reclaim unit object is determined by comparing a capacity of invalid data on the reclaim unit object with a capacity of the reclaim unit object, the capacity of the invalid data includes a capacity of data file objects that have been deleted and a capacity of candidate data file objects written into the reclaim unit object, and the candidate data file objects are data file objects belonging to the sets of data file objects, and the file overlapping rate of the reclaim unit object is determined by comparing a number of the candidate data file objects written into the reclaim unit object with a number of all data file objects written into the reclaim unit object.

According to some example embodiments of the present disclosure, there is provided a garbage collection method for a solid state drive, the garbage collection method includes receiving a reference lifetime of a reclaim unit object transmitted by a host side connected to the solid state drive, the reference lifetime of the reclaim unit object obtained by counting historical lifetimes of the reclaim unit object, the historical lifetimes include lifetimes of other objects in the solid state drive related to the reclaim unit object; and performing garbage collection according to the received reference lifetime of the reclaim unit object.

In some example embodiments, the performing the garbage collection according to the received reference lifetime of the reclaim unit object includes excluding, during performing of the garbage collection, the reclaim unit object of which the reference lifetime has not expired.

In some example embodiments, the receiving the reference lifetime of the reclaim unit object transmitted by the host side connected to the solid state drive includes receiving a reference lifetime of a reclaim unit handle transmitted by the host side, and configuring the reference lifetime of the reclaim unit handle to be reference lifetimes of all reclaim unit objects to which the reclaim unit handle points.

According to some example embodiments of the present disclosure, there is provided a garbage collection device for a host side, the garbage collection device including an obtaining unit configured to obtain, for each of target objects in a solid state drive connected to the host side, lifetimes of other objects related to each of the target objects in the solid state drive as historical lifetimes of each of the target objects, the target objects include at least one of a reclaim unit object or a data file object, the reclaim unit object is a physical storage unit configured to store the data file object in the solid state drive; a counting unit configured to count the historical lifetimes of each of the target objects to obtain a reference lifetime of each of the target objects; and a performing unit configured to perform garbage collection based on reference lifetimes of the target objects.

In some example embodiments, the obtaining unit is further configured to, based on the target object including the reclaim unit, use a reclaim unit handle pointing to the target object as a target reclaim unit handle, and obtain lifetimes of a plurality of historical reclaim units to which the target reclaim unit handle pointed as the historical lifetimes of the target object; and based on the target object including the data file, use a file level in which the target object is located as a target file level, and obtain lifetimes of a plurality of historical data files that existed in the target file level as the historical lifetimes of the target object.

In some example embodiments, the obtaining unit is further configured to obtain the lifetimes of the plurality of historical reclaim units to which the target reclaim unit handle pointed as historical lifetimes of all of the target objects to which the target reclaim unit handle points; and obtain the lifetimes of the plurality of historical data files that existed in the target file level as historical lifetimes of all of the target objects in the target file level.

In some example embodiments, the counting unit is further configured to count a value range of the historical lifetimes of each of the target objects; and determine a specified quartile of the value range as the reference lifetime of each of the target objects.

In some example embodiments, the historical lifetimes are continuously updated over time, and the counting unit is further configured to count the historical lifetimes of each of the target objects to obtain the reference lifetime of each of the target objects based on a determination that a workload of the solid state drive has changed, at a cycle.

In some example embodiments, the performing unit is configured to transmit the reference lifetime of the reclaim unit object of the target objects to the solid state drive to configure the reclaim unit object of the target objects as not to participate in garbage collection until the reference lifetime corresponding to the reclaim unit object expires.

In some example embodiments, the garbage collection device further includes a gathering unit configured to gather object information of each of objects in the solid state drive belonging to categories that are identical to those of the target objects, wherein the object information includes start-life-time, lifetime, and a storage relationship, wherein the start-life-time of the reclaim unit object is a time the reclaim unit object is assigned to be used for writing a data file object, wherein the storage relationship of the reclaim unit object includes the data file object written into the reclaim unit object, the start-life-time of the data file object is a creation time of the data file object, and the storage relationship of the data file object includes the reclaim unit object into which the data file object is written.

In some example embodiments, the performing unit is further configured to determine, for sets of data file objects on which the garbage collection is to be performed, a factor of each of the sets of data file objects according to the object information and the reference lifetimes involved in each of the sets of the data file objects, wherein each of the sets of data file objects includes a plurality of data file objects to be simultaneously reclaimed, and wherein the factor is based on a performance gain resulting from reclaiming each of the sets of data file objects; determine a reclaiming order of the sets of data file objects according to factors of the sets of data file objects; and perform the garbage collection on the sets of data file objects according to the reclaiming order.

In some example embodiments, the factor includes at least one of a life factor of the data file object, a life factor of the reclaim unit object, a failure rate of the reclaim unit object, or a file overlapping rate of the reclaim unit object, the life factor of the data file object is determined by comparing survival duration with the reference lifetime of the data file object, the life factor of the reclaim unit object is determined by comparing usage duration with the reference lifetime of the reclaim unit object, the failure rate of the reclaim unit object is determined by comparing a capacity of invalid data on the reclaim unit object with a capacity of the reclaim unit object, the capacity of the invalid data includes a capacity of data file objects that have been deleted and a capacity of candidate data file objects written into the reclaim unit object, and the candidate data file objects are data file objects belonging to the sets of data file objects, and the file overlapping rate of the reclaim unit object is determined by comparing a number of the candidate data file objects written into the reclaim unit object with a number of all data file objects written into the reclaim unit object.

According to some example embodiments of the present disclosure, there is provided a garbage collection device for a solid state drive, wherein the garbage collection device includes a receiving unit configured to receive a reference lifetime of a reclaim unit object transmitted by a host side connected to the solid state drive, the reference lifetime of the reclaim unit object obtained by counting historical lifetimes of the reclaim unit object, the historical lifetimes include lifetimes of other objects in the solid state drive related to the reclaim unit object; and a performing unit configured to perform garbage collection according to the received reference lifetime of the reclaim unit object.

In some example embodiments, the performing unit is further configured to excluding, during performing of the garbage collection, the reclaim unit object of which the reference lifetime has not expired.

In some example embodiments, the receiving unit is further configured to receive a reference lifetime of a reclaim unit handle transmitted by the host side such that the reference lifetime of the reclaim unit handle is to be reference lifetimes of all reclaim unit objects to which the reclaim unit handle points.

According to some example embodiments of the present disclosure, there is provided a non-transitory computer-readable storage medium storing a computer program, wherein the computer program, based on being executed by a processor, implement the garbage collection method for the host side or the solid state drive as described herein.

According to some example embodiments of the present disclosure, there is provided an electronic device, wherein the electronic device includes at least one processor; at least one non-transitory memory storing computer-executable instructions, wherein the computer-executable instructions, based on being executed by the at least one processor, cause the at least one processor to perform the garbage collection method for the host side or the solid state drive as described herein.

In the garbage collection methods and devices for the host side and the solid state drive, the storage medium, the electronic apparatus, and the program product according to some example embodiments of the present disclosure, by counting the lifetimes of other objects related to the target object and configuring the obtained results as the reference lifetime of the target object, may speculate whether the target object is at the end of life, e.g., whether the target object is close to expiry or not, so as to provide a more effective reference for performing process of garbage collection, which helps to improve the efficiency of garbage collection and/or partially or fully reduce the write amplification effect.

Additional aspects and/or advantages of the general idea of the present disclosure will be set forth in part in the following description, and still other parts will be clear through the description or may be learned after implementation of the general idea of the present disclosure.

### BRIEF DESCRIPTION OF THE DRAWINGS

The above and other purposes and features of some example embodiments of the present disclosure will become clearer by the following description in conjunction with the accompanying drawings which illustrate some example embodiments, wherein:

FIG. 1 illustrates a schematic diagram of logics of an FDP SSD as an example of an SSD according to some example embodiments of the present disclosure.

FIG. 2 illustrates an input/output path of writing for a reclaim unit of an FDP SSD as an example of an SSD according to some example embodiments of the present disclosure.

FIG. 3 illustrates a schematic diagram of a structure of an LSM-Tree employed at a host side according to some example embodiments of the present disclosure.

FIG. 4 illustrates a schematic diagram of a method of a host side controlling an SSD to write a data file according to some example embodiments of the present disclosure.

FIG. 5 illustrates a schematic diagram of another method of the host side controlling a solid state drive to write a data file according to another some example embodiments of the present disclosure.

FIG. 6 illustrates a flowchart of a garbage collection method for the host side according to some example embodiments of the present disclosure.

FIG. 7 illustrates a schematic diagram for selecting a data file object stored on a reclaim unit object that would expire at first, according to some example embodiments of the present disclosure.

FIG. 8 illustrates a schematic diagram of a process for periodically performing obtaining and counting of historical lifetimes, according to some example embodiments of the present disclosure.

FIG. 9 illustrates a schematic diagram of logics for periodically performing obtaining and counting of historical lifetimes according to some example embodiments of the present disclosure.

FIG. 10 illustrates a schematic diagram of causes of garbage collection conflicts of the related art.

FIG. 11 illustrates a schematic diagram of a process for performing garbage collection by a solid state drive according to some example embodiments of the present disclosure.

FIG. 12 illustrates a schematic diagram of logics for performing garbage collection by a solid state drive according to some example embodiments of the present disclosure.

FIG. 13 illustrates a schematic diagram of an effect of a garbage collection method according to some example embodiments of the present disclosure.

FIG. 14 illustrates a schematic diagram of a resource updating scenario according to some example embodiments of the present disclosure.

FIG. 15 illustrates a schematic diagram of another resource updating scenario according to some example embodiments of the present disclosure.

FIG. 16 illustrates a schematic diagram of performing logics of compaction by the host side, according to some example embodiments of the present disclosure.

FIG. 17 illustrates a flowchart of a garbage collection method for a solid state drive according to some example embodiments of the present disclosure.

FIG. 18 illustrates a schematic diagram of four function modules of a host side and a solid state drive according to some example embodiments of the present disclosure.

FIG. 19 illustrates a schematic diagram of three function modules of the host side according to some example embodiments of the present disclosure.

FIG. 20 illustrates a block diagram of a garbage collection device for the host side according to some example embodiments of the present disclosure.

FIG. 21 illustrates a block diagram of a garbage collection device for a solid state drive according to some example embodiments of the present disclosure.

### DETAILED DESCRIPTION

The following detailed description is provided to assist the reader in obtaining a full understanding of the methods, apparatuses, and/or systems described herein. However, various changes, modifications, and equivalents of the methods, apparatuses, and/or systems described herein will be clear after understanding the disclosure of this application. For example, the order of operations described herein is merely some example and is not limited to those set forth herein, but rather may be altered as will be clear after understanding the disclosure of this application, except for operations that must occur in a particular order. In addition, descriptions of features known in the art may be omitted for greater clarity and brevity.

The features described herein may be implemented in different forms and should not be construed as being limited to the examples described herein. Rather, the examples described herein have been provided to illustrate only some of the many practicable ways of implementing the methods, apparatuses, and/or systems described herein, the many practicable ways will be clear after understanding the disclosure of this application.

The terms used herein are used only to describe various examples and will not be used to limit the disclosure. The singular form is also intended to include the plural form unless the context clearly indicates otherwise. The terms “comprise”, “include”, and “have” indicate the presence of the descriptive features, numbers, operations, components, elements, and/or combinations thereof, but do not preclude the presence or addition of one or more other features, numbers, operations, components, elements, and/or combinations thereof.

Unless otherwise defined, all terms used herein, including technical and scientific terms, have the same meaning as commonly understood by one of ordinary skill in the art to which this disclosure pertains after understanding the disclosure. Unless expressly so defined herein, terms (such as, those defined in commonly used dictionaries) should be interpreted as having a meaning that is consistent with their meaning in the context of the relevant art and the present disclosure, and should not be interpreted in an idealized or overly formal sense.

Furthermore, in the description of the examples, when it is believed that a detailed description of a well-known relevant structure or function would result in an obscure interpretation of the present disclosure, such a detailed description will be omitted.

The present disclosure relates to an FDP technology and an LSM-Tree compaction technology. The FDP refers to host data placement technology (TP4146) which may be used in industry for reducing WAF in the SSD. The FDP technology allows the host (which refers to a computer system on which a driver runs, for example, a server or a PC) to isolate data with similar lifetimes and place them in the same media stream to reduce GC. The non-volatile memory express specification (NVMe Spec) for the FDP according to some example embodiments introduces several concepts as follows.

Reclaim unit (RU) is a group of NAND blocks into which the host may write logical blocks and is a single erasable unit of a controller.

Reclaim group (RG) is a set of a group of RUs.

Reclaim unit handle (RUH) manages and buffers logical blocks to be written to the reclaim unit, each RUH points to a RU in one RG, when the RU is full, the RUH may be switched to point to another RU in the one RG that has not yet been used, and unless the host side instructs to switch the RG, the RG to which the RUH points remains unchanged.

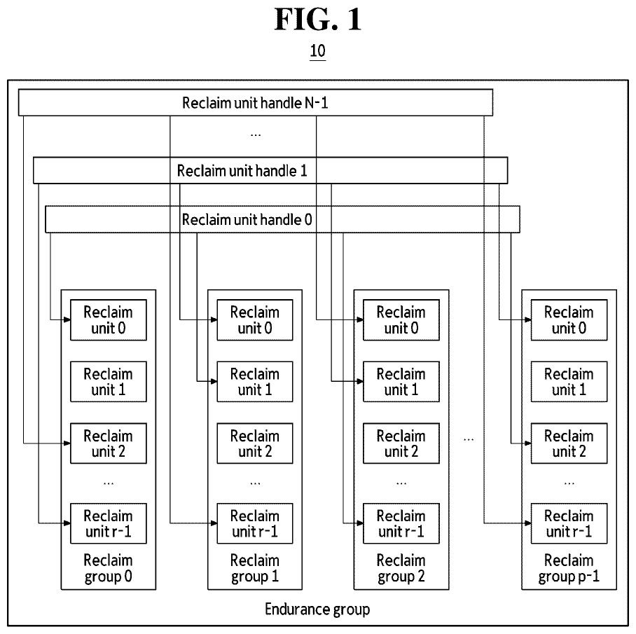

A diagram of logics of an FDP SSD is as illustrated in FIG. 1. It should be noted that each RUH in FIG. 1 pointing to RUs in different RGs simultaneously (for example, at or about at the same time) indicates that each RUH has an ability of pointing to RUs in various RGs, and does not indicate that one RUH is able to point to different RUs at the same time. The FDP SSD 10 of FIG. 1 may include an endurance group 101 including a plurality of reclaim unit handles 0 to N−1 (N being a real non-zero number) and a plurality of reclaim groups 0 to p−1 (p being a real non-zero number, where N and p may be the same number or different). Each of the plurality of plurality of reclaim groups 0 to p−1 may include a plurality of reclaim units 0 to r−1 (r being a real non-zero number, where N, p, and r may be the same number or different). Each of the reclaim unit handles 0 to n−1 may be electrically connect to or communicate with each of the plurality of reclaim units 0 to r−1 of each of the plurality of reclaim groups 0 to p−1. The FDP SSD 10 of FIG. 1 may include a plurality of endurance groups the same or similar to the endurance group 101.

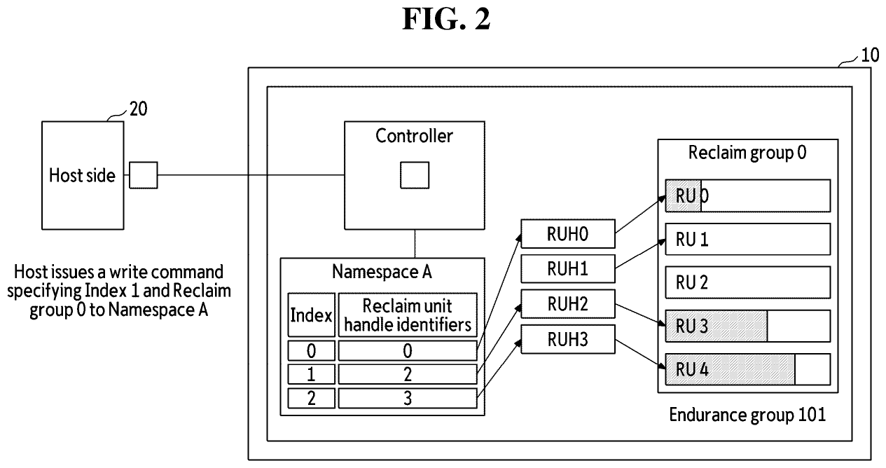

The key technical point of the FDP includes data isolation and device feedback. The data isolation means that the host may perform data separation by using the RUHs when a workload has I/O (Input/Output) modes with different lifetimes. Data with different lifetimes (e.g., hot/warm/cold) are isolated by placing them on RUs to which different RUHs refer through the RUHs. Hotter data may be accessed more frequency than warm data, which may be accessed more frequently than cold data. A diagram of I/O path of writing for a RU is as illustrated in FIG. 2. The device feedback refers to log messages defined in the FDP specification (e.g., Controller Event Log) which allows the host side to obtain detailed information about placement of data at the device side (e.g., an SSD), for example, a frequency at which the GC occurs, super block reallocation, and the like.

For example, as illustrated in FIG. 2, the host side 20 may issue a write command to the controller 110 of the endurance group 101 of the FDP SSD 10. The write command may specify index 1 of Namespace A and reclaim group 0. The controller 110 may control the FDP SSD 10 to write data using index 1 of Namespace A and reclaim group 0.

The LSM-Tree is a level-based data structure and is widely used in many key-value (KV) storage databases including a RocksDB, a LevelDB, and a Cassandra. The LSM-Tree uses an append-only write structure to eliminate random write operations on the storage device, that is, when a value corresponding to a key desire to be modified, instead of editing the value in place, an “append write” operation is performed to write a new pair of key and value. This may make writing very efficient, but at the same time, it may also result in a plurality of KV pairs for the same key, causing the amount of data actually written to be greater than the amount of data written by the user, e.g., a write amplification effect. By improving optimizing data migration and compaction, the GC may reduce repeated writing for invalid data, thereby reducing the write amplification effect and improving the performance and lifetime of the storage device. For example, according to some example embodiments, there may be an increase in reliability, operating parameters (e.g., temperature resilience), speed, accuracy, and/or power efficiency of the device based on the above methods. Therefore, the improved devices and methods overcome the deficiencies of the conventional devices and methods while reducing resource consumption, and/or improving data accuracy, operating parameters, and resource allocation (e.g., latency).

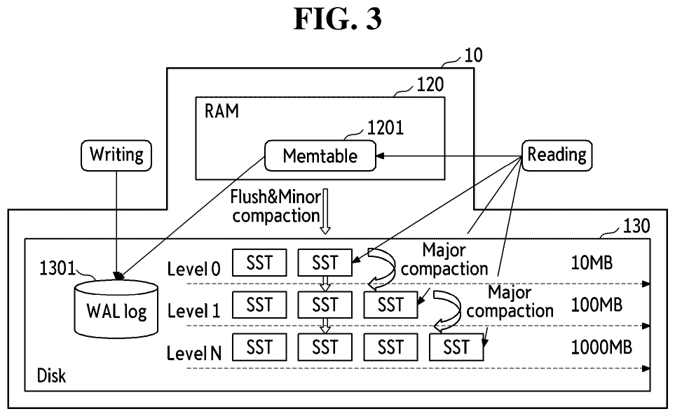

The structure of the LSM-Tree is as illustrated in FIG. 3, disclosing the LSM-Tree are SSTs (Sorted String Tables) and compaction. Each of levels of the LSM-Tree consists of a plurality of SSTs that store data as ordered key-value pairs. The SSTs at the first level (L0) of a disk 130 of the FDP SSD 10 are refreshed directly in a memory table (memTable 1201) in memory (e.g., a Random Access Memory (RAM) 120) based on Write-Ahead Logging (WAL Log) 1301, and the SSTs at subsequent levels (L1, . . . , Ln) are generated by the compaction which migrates valid key-value pairs from current level to a next level. The compaction is the GC of LSM-Tree for eliminating invalid KV pairs. A triggering mechanism may be that the compaction process is initiated to maintain structural integrity and ensure lookup performance of the LSM-Tree when a total size of SSTs at any level exceeds a predefined size limit for the any level. The function's process is to compact SSTs at level i with SSTs at level i+1. The SSTs involved in this merging and sorting are called compaction victims. This merging and sorting results in creation of a new SST in level i+1. Subsequently, the SST files involved in the compaction in layer i and layer i+1 are deleted.

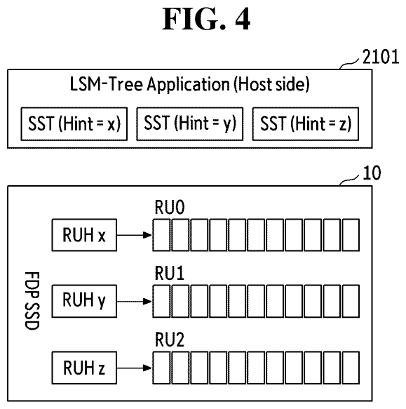

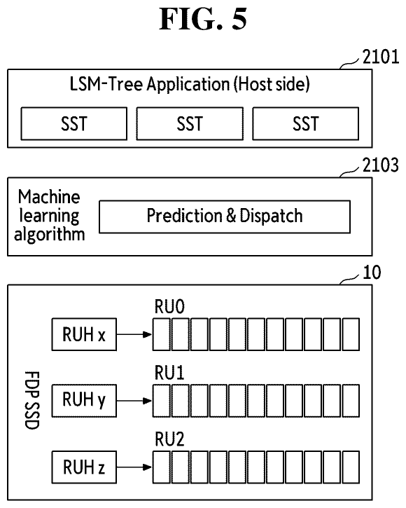

FIGS. 4 and 5 each illustrate a schematic diagram of a method of a host side controlling an SSD to write a data file according to some example embodiments of the present disclosure. Referring to FIG. 4, the SST files may be classified and placed through hints in the LSM-Tree application 2101 on the host side or level attribute of the files themselves in the FDP SSD 10.

Referring to FIG. 4, machine learning algorithms may be used to set some feature values to predict or estimate hotness of SST files, and then the files are classified based on the predicted hotness. In some example embodiments the machine learning algorithms 2103 are on the host side, in the FDP SSD 10, or a separate layer therebetween. Hotness may refer to how often an SST file is accessed by the host side and/or the SSD.

The examples in FIGS. 4 and 5 may achieve SSD WAF reduction through relatively accurate dividing of data types and these two examples focus on how to finely classify types of user data in reducing WAF. A garbage collection method based on lifetimes of SST files and lifetimes of RUs of an SSD according to some example embodiments of the present disclosure.

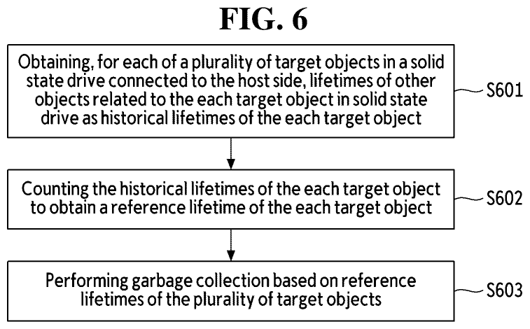

FIG. 6 illustrates a flowchart of a garbage collection method for a host side according to some example embodiments of the present disclosure. Referring to FIG. 6, the garbage collection method includes operations as follows.

In operation S601, for each of a plurality of target objects in a solid state drive connected to the host side, lifetimes of other objects related to the each target object in solid state drive are obtained as historical lifetimes of the each target object.

The plurality of target objects include at least one of a reclaim unit object (e.g., including, but not limited to, the RUs as described above) and a data file object (e.g., including, but not limited to, the SSTs as described above). The reclaim unit object may be a physical storage unit for storing the data file object in the solid state drive. In other words, from a perspective of an object category, the plurality of target objects may include only the reclaim unit object, only the data file object, or both the reclaim unit object and the data file object. In addition, from a point of view of the coverage of the target objects with respect to all the objects of a single category, the plurality of target objects may include a portion of reclaim unit objects in the solid state drive that is being used or all of the reclaim unit objects, and may also include a portion of data file objects that is currently stored in the solid state drive or all of the data file objects. The reclaim unit objects that are being used in the solid state drive refer to reclaim unit objects that have already been assigned for writing the data file objects and for which data file objects stored therein have not yet been erased, while reclaim unit objects that are not yet used are reclaim unit objects that have not yet been allocated for writing the data file objects and include a reclaim unit object that was allocated for writing data and then had the data erased and has not yet been reallocated. The data file objects that are currently stored in the solid state drive are data file objects that have been created and have not yet been erased.

In some example embodiments of the present disclosure, operation S601 may include for the target object that is the reclaim unit, using a reclaim unit handle pointing to the target object as a target reclaim unit handle, obtaining lifetimes of a plurality of historical reclaim units to which the target reclaim unit handle pointed as the historical lifetimes of the target object; for the target object that is the data file, using a file level in which the target object is located as a target file level, obtaining lifetimes of a plurality of historical data files that existed in the target file level as the historical lifetimes of the target object. By respectively defining other objects as reference objects for different categories of objects, more reliable historical lifetimes may be obtained to provide a data basis for subsequent operations. Specifically, for the reclaim unit object, since the same reclaim unit handle usually has an ability to classify user data, based on this, a plurality of historical reclaim units to which the reclaim unit handle (e.g., the target reclaim unit handle) corresponding to reclaim unit object (e.g., the target object) under discussion pointed are regarded as other objects, so that the lifetime obtained thereby has a higher reference value. For the data file object, since data file objects at the same level tend to have similar hotness, based on this, a plurality of historical data files that existed in the file level (e.g., the target file level) at which the data file object (e.g., the target object) under discussion is located are regarded as other objects, so that the lifetime obtained thereby also has a higher reference value.

In some example embodiments of the present disclosure, the operation of obtaining the lifetimes of the plurality of historical reclaim units to which the target reclaim unit handle pointed as the historical lifetimes of the target object in operation S601 may include obtaining the lifetimes of the plurality of historical reclaim units to which the target reclaim unit handle pointed as historical lifetimes of all target objects to which the target reclaim unit handle points. The operation of obtaining the lifetimes of the plurality of historical data files that existed in the target file level as the historical lifetimes of the target object in operation S601 may include obtaining the lifetimes of the plurality of historical data files that existed in the target file level as historical lifetimes of all target objects in the target file level. Since the other objects for the reclaim unit object depends on the reclaim unit handle, and the other objects for the data file object depends on the file level in which the data file object is located, based on this, repetitive data acquisition may be reduced to improve processing efficiency by using the same historical lifetime for all the reclaim unit objects to which the same reclaim unit handle points, and using the same historical lifetime for all the data file objects that are in the same level. Similarly, it should be understood that subsequent operations may also be performed only once for all reclaim unit objects to which the same reclaim unit handle points and for all data file objects at the same level, thereby improving data processing efficiency, for example to sufficiently improve device performance.

As an example, for some example embodiments in which the reclaim unit handle points to only one reclaim unit object at the same time, the reclaim unit handle may be directly used as the target object, and a plurality of historical reclaim units to which the target object pointed may be used as other objects for the target object, which also belongs to an implementation of the present disclosure. By configuring the reference lifetime of the reclaim unit handle, and then uniformly configuring the reference lifetime of all the reclaim unit objects to which the reclaim unit handle points, it is possible to ensure more reliable inheritance of the reference lifetime when the reclaim unit object to which the reclaim unit handle points changes, which may improve efficiency and reliability of a configuration.

As an example, reclaim units to which each reclaim unit handle pointed may be recorded and stored as a list and recorded in a resource of the each reclaim unit handle, in order to determine the other objects for the target object. In addition, the historical lifetimes of the target object obtained at the subsequent operation S602 may also be recorded in the resource of the reclaim unit handle related to the target object. It should be understood that, for the data file object, the reclaim unit handle related to the data file object is a reclaim unit handle that manages the data file object.

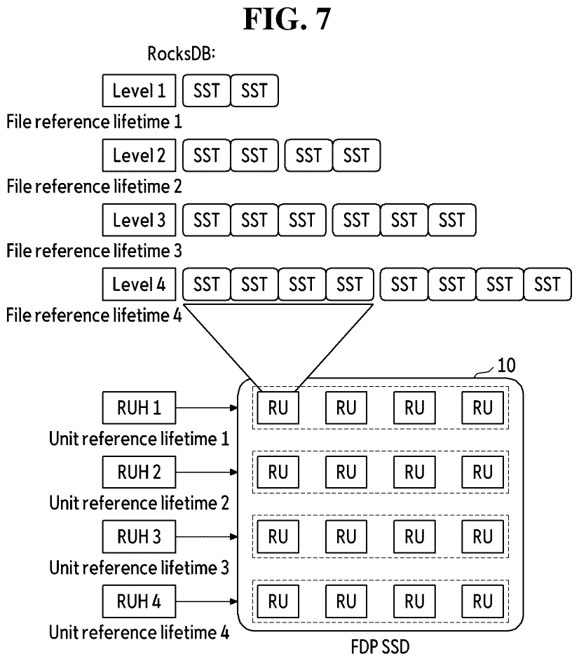

As an example, the reclaim unit objects to which the same reclaim unit handle points have the same reference lifetime, and during the garbage collection, as illustrated in FIG. 7 (for ease of differentiation, the reference lifetime of the reclaim unit object is referred to as a unit reference lifetime, and the reference lifetime of the data file object is referred to as a file reference lifetime), data file objects stored on a reclaim unit object whose usage duration is closest to a reference lifetime (e.g., the reclaim unit object that would firstly expire) are selected in priority; data file objects at the same level also have the same reference lifetime, and a data file object whose survival duration is closest to a reference lifetime (e.g., the data file object that would firstly expire) may also be selected in priority during the garbage collection. These two factors may also be considered simultaneously, and may further be combined with other factors to determine the data file object on which the garbage collection is to be performed in priority.

In operation S602, the historical lifetimes of the each target object are counted to obtain a reference lifetime of the each target object.

In some example embodiments of the present disclosure, the operation S602 may include counting a value range of the historical lifetimes of the each target object; determining a specified quartile of the value range as the reference lifetime of the each target object. By using the specified quartile of the value range of the historical lifetimes as the reference lifetime, an efficiency of calculating the reference lifetime may be improved, and a statistical criterion for the reference lifetime may be conveniently adjusted in practice by adjusting the used specified quartile, which provides higher flexibility and higher optimization potential. As an example, the specified quartile may be the 80th percentile, e.g., for 80% of values in the value range of the historical lifetimes being less than a certain value, the certain value is used as the reference lifetime.

In some example embodiments of the present disclosure, the historical lifetimes are continuously updated over time, and the operation S602 may include counting the historical lifetimes of each target object to obtain the reference lifetime of the each target object in a case that it is determined that a workload of the solid state drive has changed, at a preset cycle. By checking the workload of the solid state drive at the preset cycle and re-counting the historical lifetimes to determine the reference lifetime when the workload changes, the validity of the used reference lifetime may be ensured, thereby improving efficiency of the garbage collection. It should be understood that the specific length of the preset cycle may be set as desired and is not limited by the present disclosure. It should be understood that operation S601 should or may be re-performed to obtain new historical lifetimes when a new preset cycle starts, and only lifetime data that is newly generated in the current preset cycle may also be used as the historical lifetimes, that is, the historical lifetimes are all be cleared and re-obtained at each preset cycle, so as to more accurately reflect an actual situation in the current preset cycle. Herein, preset cycles (or values, thresholds, etc.) may refer to cycles which are desired, determined, or selected.

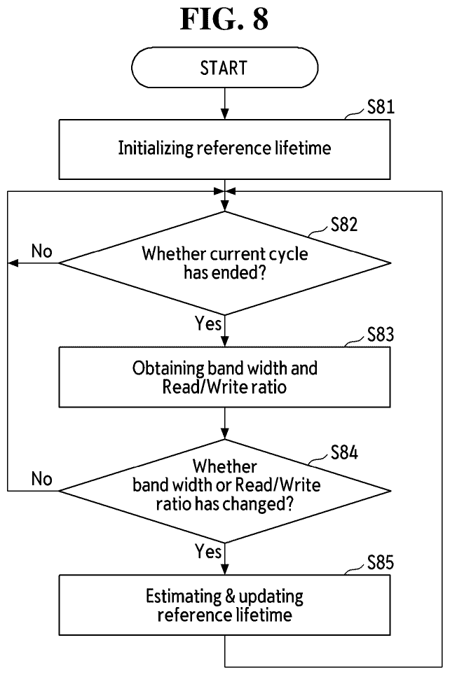

Specifically, a schematic diagram of a process for periodically performing the obtaining and counting of the historical lifetimes is as illustrated in FIG. 8. The process includes operations as follows.

In an operation 1 (S81), the preset cycle is set as T and the reference lifetime of each target object is initialized by using a default value.

In an operation 2, it is determined if a cycle (e.g., the first cycle) has ended (S82). If the cycle has not ended (No), S82 is repeated. When the first cycle ends (Yes), a default workload has changed, the historical lifetimes of the each target object are obtained (specifically referring to operation S601), and counted to obtain the reference lifetime of the each target object (specifically referring to operation S602) as the reference lifetime of the second cycle (S83).

In an Operation 4 subsequently, whenever a single cycle ends, whether the workload has changed is checked (S84). If the workload has changed (Yes), operation 2 is re-performed (S85), otherwise (if the workload has not changed (No)) operation 2 is not performed and an old value of the reference lifetime is used (S82).

As an example, two parameters, a band width (BW) and a read/write ratio (rw_ratio), may be used to represent the workload, and it is considered that the workload has changed if at least one of these two parameters has changed.

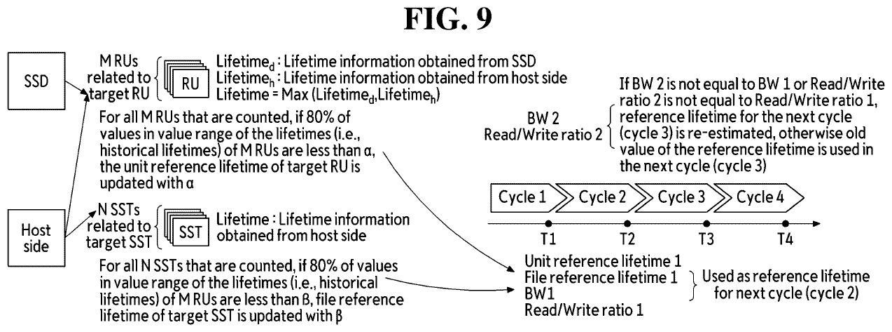

As an example, as illustrated in FIG. 9, the obtaining and counting of the historical lifetimes may be performed periodically in conjunction with the above two some example embodiments, and a specified quartile of the value range of the historical lifetimes is specifically used as the reference lifetime. In addition, when obtaining the historical lifetimes, if the lifetime of the reclaim unit object is involved, for some example embodiments in which the lifetime of the reclaim unit is counted on both the host side and the SSD, the lifetimes of the same reclaim unit counted on both the host side and the SSD may differ from each other. The larger value of the counted two lifetimes may be used as the lifetime of the reclaim unit, and an average or other statistical values of the two lifetimes may be used as the lifetime of the reclaim unit, which is not limited by the present disclosure.

Referring back to FIG. 6, in operation S603, garbage collection is performed based on reference lifetimes of the plurality of target objects.

Some example embodiments of performing garbage collection based on the reference lifetimes is next described.

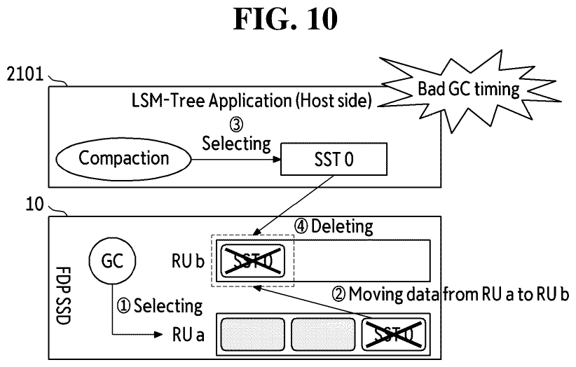

Upon analysis, different garbage collection operations may be performed at the solid state drive and the host side respectively, for example, erasing data on the reclaim unit by the solid state drive and the compaction of the host side as previously described. For the former, the solid state drive first move valid data files on the reclaim unit to be erased to another reclaim unit before performing an erasing operation. As illustrated in FIG. 10, when the solid state drive moves the data file SST 0 from the reclaim unit RU a to the reclaim unit RU b in order to perform the garbage collection (GC), if the data file SST0 is a data file that is to be selected for the garbage collection (compaction) and is to be deleted by the host side, that is, the data file moved by the solid state drive is a data file that is to be deleted, a garbage collection conflict between the host side and the solid state drive is caused, which results in redundant moving operations, occurring of unnecessary garbage collection in the solid state drive, and a waste of device resources.

In order to solve or improve upon the problem, in some example embodiments of the present disclosure, operation S603 may include transmitting the reference lifetime of the reclaiming unit object of the plurality of target objects to the solid state drive, so as to configure the reclaiming unit object of the plurality of target objects as not to participate in garbage collection until the reference lifetime corresponding to the reclaiming unit object expires. By configuring the reclaim unit objects that are about to expire as not to participate in the garbage collection, that is, the data file object is not moved, redundant moving operations may be effectively reduced, thereby conserving resources, and improving garbage collection efficiency.

As an example, a reference lifetime field may be added into a configuration descriptor of the reclaim unit handle of the FDP, and a setting interface may be configured at the host side to set an attribute of the reclaim unit handle in the solid state drive using the setting interface. If the value of the field is 0 h (0 hours) in the attribute of certain reclaim unit handle, the value means that the reference lifetime is not set; if the value of the field is greater than 0 h, the value means that the reference lifetime is set, and all the reclaim unit objects to which the reclaim unit handle points inheriting the attribute have the corresponding time limit, and the reclaim unit objects are not allowed to be selected by the GC of the solid state drive until the time limit is reached.

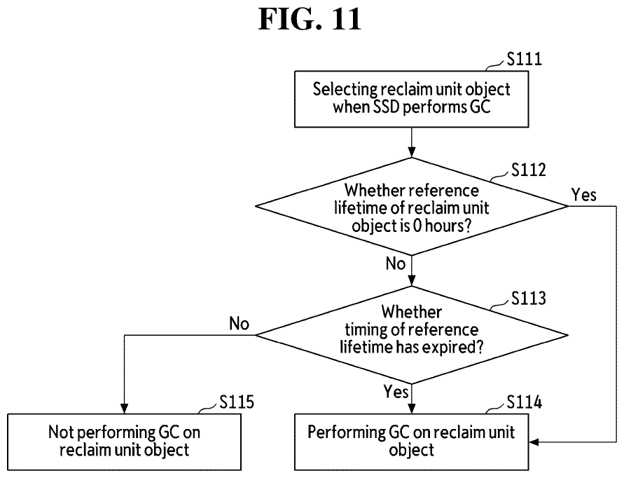

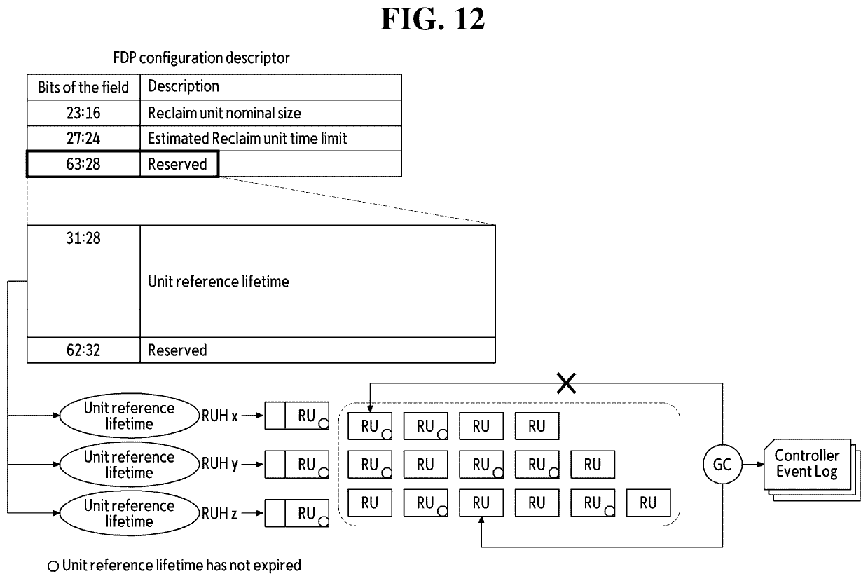

FIG. 11 is a schematic diagram of a process for performing garbage collection by the SSD, and FIG. 12 is a schematic diagram of logics of performing the process. As illustrated in FIGS. 11 and 12, when the garbage collection of the solid state drive is to select a reclaim unit object (S111), a reference lifetime should or may be extracted from the attribute of the reclaim unit handle of a reclaim unit object that is currently prepared to be selected by the garbage collection for the solid state drive, and then whether timing of the reference lifetime has timed out is determined (S112). If the reference lifetime does not exist (Yes at S112) or the set reference lifetime has expired (Yes at S113), a normal garbage collection process is performed and a controller event log is recorded after the garbage collection is completed (S114). If the reference lifetime has been set and the set reference lifetime has not expired (No at S113), the garbage collection will not be performed on the reclaim unit object at this time S115. If there is another reclaim unit object that may be selected and for which the reference lifetime is not set or the timing of the reference lifetime has timed out, the garbage collection may be performed on the other reclaim unit object.

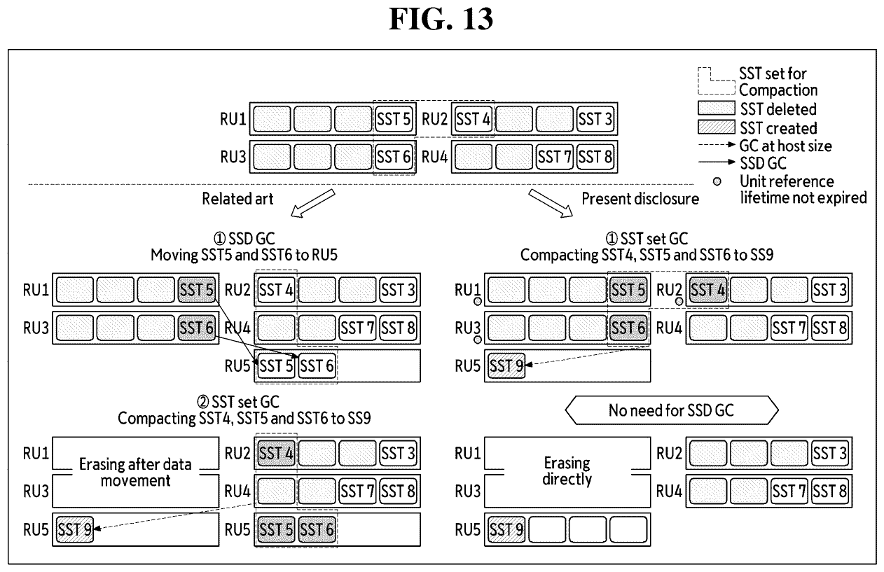

FIG. 13 illustrates an effect of the some example embodiments of the present disclosure described above as compared to the related art. As illustrated in FIG. 13, when the host side is about to perform a garbage collection operation of compacting SST4 on RU2, SST5 on RU1, and SST6 on RU3, and the solid state drive is about to perform a garbage collection operation of moving SST5 and SST6 to a new RU5, the related art performs the redundant garbage collection operation of the solid state drive firstly, and then performs the garbage collection operation of the host side. The above some example embodiments of the present disclosure does not perform garbage collection on RU1, RU2, and RU3 temporarily because the reference lifetimes of RU1, RU2, and RU3 have not expired, and then performs the garbage collection operation of the host side, so that there is no need to perform the garbage collection operation of the solid state drive. That is, in some example embodiments, when the reference lifetimes of RU1, RU2, and RU3 have not expired a garbage collection may not be performed.

Before introducing another some example embodiments of performing garbage collection based on the reference lifetimes, an operation of gathering information that may be performed before performing operation S601 of the some example embodiments of the present disclosure is introduced.

In some example embodiments of the present disclosure, prior to operation S601, the garbage collection method may further include gathering object information of each of objects in the solid state drive belonging to categories that are identical to those of the plurality of target objects, wherein the object information includes start-life-time, lifetime, and a storage relationship, wherein the start-life-time of the reclaiming unit object is the time when the reclaiming unit object is assigned to be used for writing a data file object, wherein the storage relationship of the reclaiming unit object includes a data file object written into the reclaiming unit object, the start-life-time of the data file object is the time of creating the data file object, and the storage relationship of the data file object includes a reclaiming unit object into which the data file object is written. By collecting the start-of-life time, a state of lifetime of a corresponding object may be continuously monitored based thereon, and usage duration (a difference between current time and the start-of-life time of the object) of the reclaim unit object that is currently being used may be determined at any time for the reclaim unit object, or survival duration (a difference between the current time and the start-of-life time of the object) of a data file object that is currently stored may be determined for the data file object. When the life of any object ends, a difference between the current time (e.g., the end-life-time of the any object) and the start-of-life time of the any object may also be determined as the lifetime of the any object. By collecting the storage relationship, a storage situation of the object may be quickly obtained from a perspective of a single reclaim unit object or a single data file object, thus improving a usage efficiency of information.

As an example, one function module may be configured on the host side to manage these object information in a uniform manner, thereby providing a basis for performing of subsequent operations. Also, the process of gathering and recording the information may specifically include at the beginning of the lifetime of an object, a corresponding entry is created and start-life time of the object is recorded, then the storage relationship of the object is updated while the solid state drive is used, and then, when the lifetime of the object ends, the lifetime of the object is calculated, and historical lifetimes related to the object are updated accordingly. For example, the value range of the historical lifetimes related to the object is directly updated, and the historical lifetimes are stored in the resource of the reclaim unit handle described above.

For example, the host side may record the start-life-time and the storage relationship of the reclaim unit object as a Shadow RU resource, wherein the Shadow RU means that what the host side manages is a virtual resource, a shadow of the RU of the solid state drive. The start-life-time and the storage relationship of the data file object may be recorded as an SST file resource, and the resource of the reclaim unit handle is recorded as a RUH resource. The host side may be configured with a getting interface for obtaining controller event logs related to reallocation of the reclaim unit objects recorded after performing of the garbage collection for the solid state drive, in order to obtain information related to reclaim unit objects that have been reclaimed.

For the SST file resource, a record may be created when an SST file is created and a current timestamp may be recorded as creating time of the SST file as start-of-life time of the SST file. An RU into which the SST file is written may also be recorded and stored as a list, that is, the RU is used as a storage relationship, so that a factor of a relevant RU may be quickly traversed and obtained when the SST file is selected for the compaction. When the SST file is deleted, the lifetime of the SST file is calculated based on the current time and a creation time of the SST file, and a range of lifetimes of SSTs in the RUH resource is updated, and, as previously mentioned, for some example embodiments that perform counting periodically according to the preset cycle, the range of lifetimes of the SST in the RUH resource may also be cleared to be re-updated at each preset cycle. When ranges of lifetimes of a plurality of historical data files in a single level should be obtained, the range of lifetimes of SSTs in the RUH resource corresponding to each historical data file may be used as the range of lifetimes of the each historical data file, and then the ranges of lifetimes of the plurality of historical data files may be merged together to obtain a larger value range as a value range of historical lifetimes of the data file object in the level.

For the Shadow RU resource, when a RU to which a RUH points to is full, the RUH may automatically switch to point to another empty RU, and the host side may also switch the RUH to point to an empty RU with a command. Once a RU is pointed by the RUH, e.g., the RU is allocated, a record may be created and a current timestamp may be recorded as activating time of the RU as a start-of-life time of the RU. During the usage of a RU, SST files that are written into the RU may be recorded and stored as a list, that is, the SST files is used as a storage relationship. When the list for files of the RU is cleared, a lifetime of the RU is calculated and a range of lifetimes of the RU (e.g., the value range of the historical lifetimes of the reclaim unit object or the reclaim unit handle) in the RUH resource is updated.

As an example, for the LSM-Tree, there are two scenarios for resource updating, which are triggered by a flushing operation (a refreshing operation or a persisting operation) and deleting operation respectively.

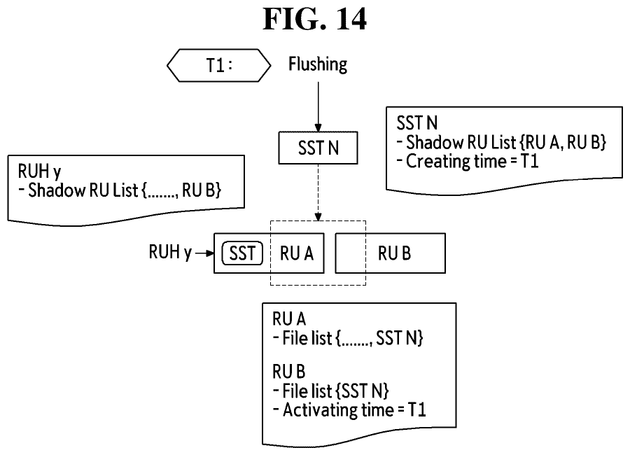

The flushing operation refers to writing memory table data in memory into a disk to generate an SST file. The resource updated due to the flushing operation is as illustrated in FIG. 14. When a new SST file is generated at T1, an entry of an SST file, denoted as SST N, is created in the SST file resource, and the creating time of SST N is updated to be the current timestamp {T1}. SST N is written into two RUs, so the Shadow RU list of SST N is updated to be {RU A, RU B}. Also, the file list of the RU A of the Shadow RU resource is updated by newly adding SST N. An entry for RU B is newly added, the file list of RU B is updated to be {SST N}, and activating time of RU B is updated to be the current timestamp {T1}. Among the RUH resources, RUH y is switched from pointing to RU A to pointing to RU B, and a Shadow RU list of RUH y is updated.

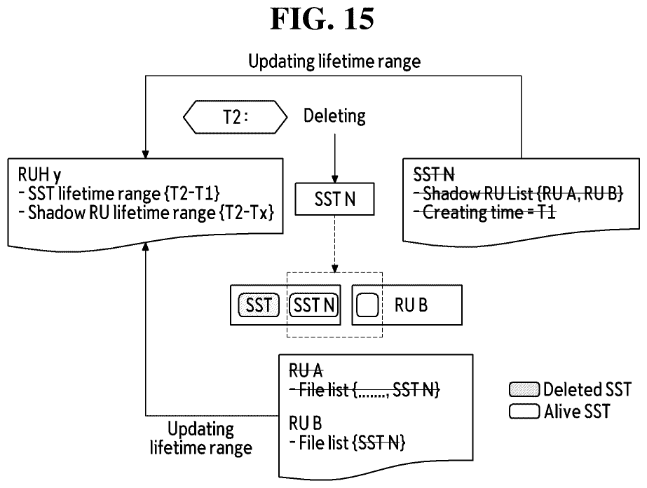

The deleting operation does not delete data directly, but marks deletion for the data by inserting a tombstone marker, and the data marked to be deleted would be actually cleaned up in a subsequent compaction process. The resource updating resulting from the deleting operation is as shown in FIG. 15, and when the tombstone marker is inserted for SST N at a moment of T2, the entry of SST N in the SST file resource is deleted, and an SST file lifetime range for RUH y in the RUH resource is updated according to the lifetime (T2−T1) of the SST N. File lists of RU A and RU B in the Shadow RU resource are updated, and the SST N is deleted. Since other SST files stored on RU A have been deleted previously, the file list of RU A is empty after deletion of SST N, and thus there is no valid data on RU A, and the list is deleted from the Shadow RU resource, and a Shadow RU lifetime range for the RUH y in the RUH resource is updated based on the lifetime (T2−Tx) (Tx is the activating time of RU A) of RU A.

Another some example embodiments of performing garbage collection based on the reference lifetimes is described next.

In the related technology, if the compaction is triggered at the host side, SST files that should be compacted into a next level may be analyzed as selected files, and then, for each selected file, files in the next level each of which has a key overlapping with that of the each selected file are found, and the each selected file is merged together with the found files in the next level. These files that are to be merged together may be recorded as a set of data file objects. If the number of the selected files is more than one, e.g., the number of sets of data file objects is more than one, a priority order of the set of data file objects may be determined and the set of data file objects is compacted according to the order.

There may be solutions for determining the priority order based on a key failure rate of an SST file or a key overlapping rate of SST files to be compacted. The key failure rate is a ratio of keys that have been deleted of the SST file, e.g., a ratio of the number of keys that have been deleted of the SST file to the number of all keys of the SST file. After creating an SST file, some of keys of the file may be discarded due to operations on the host side, and the more failed keys there are, the sooner the SST file should be reclaimed, and accordingly the greater the key failure rate is, the higher the priority of a corresponding SST file is. Although the key overlapping ratio of the SST files to be compacted may be called the key overlapping ratio, the key overlapping ratio may be more closely related to and actually calculated to be a capacity of SST files belonging to the next level of a set of data file objects multiplied by 1024 and then divided by a capacity of SST files belonging to a current level. The smaller the key overlapping ratio is, the higher the priority of the corresponding set of data file objects is. However, such solutions may only considers the SST files.

In some example embodiments of the present disclosure, the operation S603 may include determining, for a plurality of sets of data file objects on which the garbage collection is to be performed, a preset factor for each set of data file objects according to the object information and the reference lifetimes involved in the each set of the data file objects, wherein the each set of data file objects includes a plurality of data file objects that are to be simultaneously reclaimed, and the preset factor is used for reflecting a performance gain resulting from reclaiming the each set of data file objects; determining a reclaiming order of the plurality of sets of data file objects according to the preset factors of the plurality of sets of data file objects; performing the garbage collection on the plurality of sets of data file objects according to the reclaiming order. By comprehensively using the object information and the reference lifetimes to determine the preset factor reflecting the performance gain, and determining the recycling order (e.g., the aforementioned priority order) accordingly, the garbage collection order for the data file objects may be further optimized, which helps to select the optimal set of data object files to reduce write amplification during the garbage collection, thereby further improving the efficiency of the garbage collection.

As an example, for a case that a plurality of preset factors are used, the values of the plurality of preset factors may be normalized firstly, and in order to reduce influence of data noise, a threshold value may be set for each preset factor, so as to filter out a factor value that does not meet standards or requirements (according to the actual meaning of the preset factors, the factor values that are less than the threshold value may be filtered out, or the factor values that are greater than the threshold value may be filtered out, which is not limited by the present disclosure), and then a weighted average of remaining values of the normalized factors is calculating as a score. With respect to weights used in the calculating, when correlations between respective factors and the reclaim sorting priority are identical to each other, for example, the correlations are all positive correlations (e.g., the greater the value of the factor is, the higher the performance gain is, and the more suitable the factor is to be reclaimed in priority), the weights of respective factors are all positive; when the correlations for the respective factors are not identical to each other, e.g., one part of the factors is positively correlated with reclaim priority, and the other part of the factors is negatively correlated with the reclaim priority, weights of some of the factors are positive, and weights of some of the factors are negative. For example, factors with a positive correlation have positive weights and factors with a negative correlation have negative weights. In addition, to facilitate weighting, a sum of the weights of the respective factors may be defined in advance, for example, the sum is defined to be 1, and the defining may hold regardless of whether the correlations of the respective factors are identical to each other.

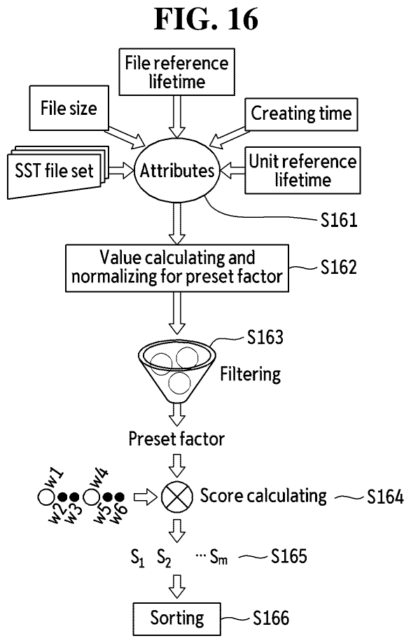

As an example, FIG. 16 is a schematic diagram of a performing logic of compaction at the host side, a process of which includes operations as follows.

In an operation 1, sets of SST files (e.g., the sets of data file objects) that are candidates for compaction are traversed to extract relevant attributes (S161) and calculate values of the preset factors, and a value of each of the preset factors is normalized (S162), and values of the preset factors that do not meet standards or requirements (as discussed above) are filter out by using a threshold value filter (S163).

It should be understood that in the process of the compaction, the sets of SST files to be compacted are determined when a level to be compacted is selected, which belongs to contents of the related technology, and will not be described in detail and repeated here. For these sets of SST files, a matrix F may be obtained by calculating the values of the preset factors for each set of SST files according to an equation for calculating the preset factors, and normalizing and filtering the values of the preset factors, for example:

$$F = \begin{matrix}SST Set 1 \\ SST Set 2 \\ ⋮ \\ SST Set m\end{matrix} {( \begin{matrix}0.8 & 0.4 & 0.2 & ⋯ & 0.1 \\ 0.3 & 0.7 & 0 & ⋯ & 0.4 \\ ⋮ & ⋱ & ⋱ & ⋱ & ⋮ \\ 0.5 & 0 & 0 & ⋯ & 0.3\end{matrix} )}^{\begin{matrix}Factor 1 & Factor 2 & Factor 3 & ⋯ & Factor n\end{matrix}}$$

In this matrix, the SST Set denotes the set of SST files that is a candidate for compaction, and the Factor denotes the preset factor.

In an operation 2, a score of each set of SST files is calculated according to the values and weights of the preset factors (S164).

This operation sets a corresponding weight w for each preset factor according to an impact of each preset factor, and how to set the weight is not limited here. The sum of these weights is 1, the weights of respective preset factors may be expressed as follows:

W=(w₁ w₁ . . . wn).

In some example embodiments, the weighted average is calculated based on the matrix F and the weights W to obtain a score for each set of the SST files, and a row vector S consisting of the scores of all sets of the SST files (S165) may be expressed as follows:

S=(s₁ s₂ . . . sₘ);

S^{T}=F×W^{T}.

In an operation 3, the sets of the SST file are sorted according to the scores from highest to lowest, and the set of SST files with the highest score is selected for compaction (S166).

In some example embodiments of the present disclosure, the preset factor includes at least one of a life factor of the data file object, a life factor of the reclaiming unit object, a failure rate of the reclaiming unit object, a file overlapping rate of the reclaiming unit object. By introducing these preset factors, reference information for more dimensions may be provided, which helps to improve optimize the reclaim order.

Specifically, the life factor of the data file object is determined by comparing survival duration with the reference lifetime of the data file object. The survival duration of the data file object is a length of duration experienced from the creating time of the object to the current time. When the survival duration of the data file object is longer than the reference lifetime, it is considered that the data file object's survival duration is likely to exceed survival durations of other data file objects on the current reclaim unit object, which may result in storing of files with different lifetimes in a mixed manner, and thus the data file object should be reclaimed as early as possible. The greater the difference between the survival durations is, the higher the priority that the data file object is selected for garbage collection. As an example, a ratio of the survival duration of the data file object to the corresponding reference lifetime may be used as the life factor of the data file object. For example, the difference may be measured in standard deviations based on the survival durations of other data file objects or threshold values.

The life factor of the reclaim unit object is determined by comparing a usage duration with the reference life cycle of the corresponding reclaim unit object. The usage duration of the reclaim unit object is the length of duration experienced from the activating time of the object to the current time. The larger this usage duration is compared to the reference lifetime, indicating that a higher priority for being early reclaimed, the higher the priority of the data file objects on the reclaim unit object is to be selected for garbage collection r. As an example, a ratio of the usage duration of the reclaim unit object to the corresponding reference lifetime may be used as the life factor of the reclaim unit object.

The failure rate of the reclaiming unit object is determined by comparing a capacity of invalid data on the reclaiming unit object with a capacity of the reclaiming unit object. The capacity of the invalid data includes a capacity of data file objects that have been deleted and a capacity of candidate data file objects written into the reclaiming unit object, and the candidate data file objects are data file objects belonging to the each set of data file objects. The data file objects that have been deleted are data that has clearly been deleted, and the candidate data file objects are data that may be about to be deleted, and the two together being as invalid data may reflect an impact of the current set of data file objects being selected to be reclaimed. The greater the capacity of the invalid data is, the less valid data on the reclaim unit object is, and the higher the priority of the data file objects thereon being selected for garbage collection is. As an example, a ratio of a capacity of the invalid data on the reclaim unit object to a capacity of the reclaim unit object may be used as a failure rate thereof. As an example, among the invalid data on the reclaim unit object, the data file objects that have been deleted may refer to data file objects that have been marked with a tombstone marker.

The file overlapping rate of the reclaiming unit object is determined by comparing the number of the candidate data file objects written into the reclaiming unit object with the number of all data file objects written into the reclaiming unit object. The preset factor is concerned with whether the selected data object files are located on the same reclaim unit object, and if the data file objects are selected on the same reclaim unit object and garbage collection is performed on the selected data file objects, it is more likely that the reclaim unit object would be released after the garbage collection, and the priority of the data file objects thereon being selected for garbage collection would be higher. In actual calculations, the more data file objects among all the data file objects written on the same reclaim unit belonging to the current set of data file objects are, the higher the priority of the data file objects on the reclaim unit object being selected for garbage collection is considered to be. As an example, a ratio of the number of candidate data file objects written into the reclaim unit object to the number of all data file objects written into the corresponding reclaim unit object may be regarded as the file overlapping ratio.

It is to be noted that some of the above preset factors are set with respect to the data file objects and others of the above preset factors are set with respect to the reclaim unit objects, and what is ultimately obtained is the preset factor for the set of data file objects. When specific calculations are performed, with respect to the preset factors for the data file objects, values of the preset factor for respective data file objects in the set may be calculated, and a maximum value may be selected as the value of the corresponding preset factor for the set. With respect to the preset factor for the reclaim unit objects, values of the preset factor of respective reclaim unit objects into which respective data file objects in the set are written may be calculated, and a maximum value may be selected as the value of the corresponding preset factor for the set.

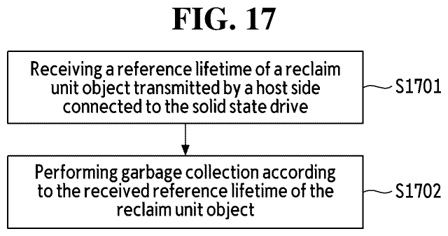

FIG. 17 illustrates a flowchart of a garbage collection method for a solid state drive according to some example embodiments of the present disclosure. Referring to FIG. 17, the garbage collection method includes operations as follows.

In operation S1701, a reference lifetime of a reclaiming unit object transmitted by a host side connected to the solid state drive is received.

The reference lifetime of the reclaiming unit object is obtained by counting historical lifetimes of the reclaiming unit object, and the historical lifetimes include lifetimes of other objects in the solid state drive related to the reclaiming unit object. With specific reference to the description of the garbage collection method for the host side in the previous section, the details will not be repeated herein.

In some example embodiments of the present disclosure, operation S1701 may include receiving a reference lifetime of a reclaiming unit handle transmitted by the host side, configuring the reference lifetime of the reclaiming unit handle to be reference lifetimes of all reclaiming unit objects to which the reclaiming unit handle points. By configuring the reference lifetime of the reclaim unit handle, and then uniformly configuring the reference lifetimes of all the reclaim unit objects to which the reclaim unit handle points, it is possible to ensure more reliable inheritance of the reference lifetime when the reclaim unit object to which the reclaim unit handle points changes, which may improve efficiency and reliability of a configuration.

In operation S1702, garbage collection is performed according to the received reference lifetime of the reclaiming unit object.

In some example embodiments of the present disclosure, operation S1702 may include excluding, during performing of garbage collection, the reclaiming unit object of which the reference lifetime has not expired. By configuring the reclaim unit objects that are about to expire as not to participate in the garbage collection, that is, the data file object is not moved, redundant moving operations may be effectively reduced, thereby conserving resources, and improving garbage collection efficiency.

In general, the garbage collection method according to some example embodiments of the present disclosure may be applied to FDP SSDs. By adding a reference lifetime field to the FDP configuration descriptor and providing an API (Application Programming Interface) for the host side to modify the configuration of the RUH, a RU to which the RUH points may automatically inherit corresponding attributes so that the solid state drive will not select the RU for GC for a period of time during which the reference lifetime has not yet expired. The some example embodiments according to the present disclosure also predict (or estimate) and update values of the reference lifetimes based on the historical lifetimes of SST files and the RUs and based on current changes in the workload. The some example embodiments according to the present disclosure also consider a plurality of preset factors for the set of SST files and calculate a score of the selected set of SST files. The score may affect a compaction priority of the set of SST files so that a set of SST files on the RU is deleted according to the compaction priority before the solid state drive performs a GC on the RU. The some example embodiments according to the present disclosure may be applicable to host data placement SSDs, including but not limited to flexible data placement SSDs, Open-Channel SSDs. The some example embodiments according to the present disclosure solve or improve upon the problem of GC conflict between the host side and the solid state drive, which may effectively reduce the in-disk GC, reduce the write amplification, and prolong the service life of the SSDs. Also, due to the reduction of GC, the negative impact of migrating data on the underlying flash memory bandwidth is reduced, which may effectively improve the performance and QoS (Quality of Service) of the FDP SSD.

Next, a garbage collection method for a host side and a solid state drive of some example embodiments of the present disclosure is described.

Some example embodiments propose a method in which a host-side policy and the GC of the solid state drive cooperate to ensure that SST files on the same RU on which compaction may be performed are deleted according to compaction priority before the solid state drive performs the GC on the RU. In some example embodiments, the solid state drive provides a RUH configuration item to set a limit for the time of Device-GC (e.g., the GC performed by the solid state drive) selecting the RU, and the host side performs compaction based on characteristics of the RU of the FDP before the Device-GC selects the RU.

To achieve functions, some example embodiments introduce additional concepts related to the lifetime, for example, ERUGCTL (Estimated Reclaim Unit Garbage Collection Time Limit) and ESSTDTL (Estimated SST Deletion Time Limit), the former is the reference lifetime of the reclaim unit object described above, and the latter is the reference lifetime of the data file object described above.

The ERUGCTL refers to when the RU does not perform data migration for GC within this time limit. The host side may transmit a setting command of the RUH attribute of the FDP SSD based on a learning result, so that the RUH and all the RUs to which the RUH points have the attribute and will not be selected by the SSD GC before they expire, thus providing time for the compaction for reclaiming at the host side.

The ESSTDTL refers to an expected lifetime of the SST file in each level of the LSM-Tree for the current period of time. The fact that approaching this time limit or the time limit has expired means that the SST file should be selected and deleted by the compaction in priority.

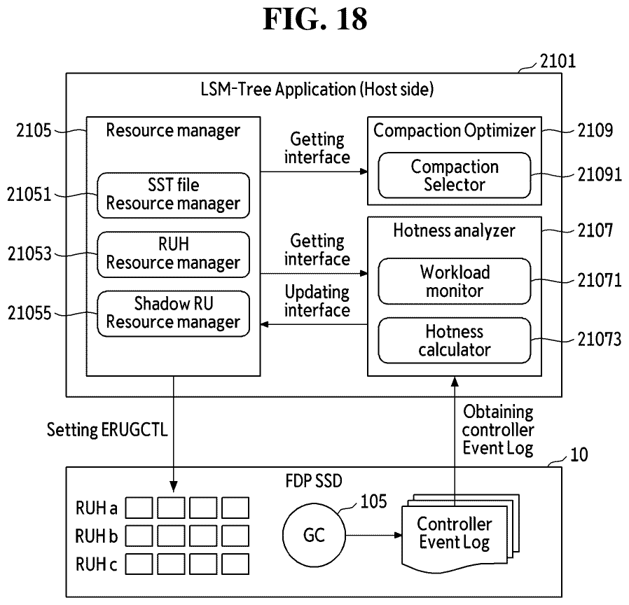

Some example embodiments achieve features through the four function modules of a Resource Manager 2105, a Hotness Analyzer 2107, and a Compaction Optimizer 2109 of the LSM-tree application 2101, and an SSD GC 105 of the FDP SSD 10 as in FIG. 18.

The resource manager 2105 may include an SST file resource manager (or SST manager) 21051, a RUH resource manager (or RUH manager) 21053, and a shadow RU resource manager (or shadow RU manager) 21055, which are used to maintain SST file resources, RUH resources, and shadow RU resources, respectively, and provide a basis for the hotness analyzer 2107 and the compaction optimizer 2109. The details of these resources may refer to descriptions above and will not be repeated here.

The hotness analyzer 2107 includes a workload monitor 21071 and a hotness calculator 21073. The workload monitor 21071 is used to periodically determine whether the workload has changed, and the hotness calculator 21073 is used to, in a case that the workload monitor 21071 determines that the workload has changed, gather lifetimes of Shadow RUs and SST files from the resource manager and lifetimes of RUs from the solid state drive, use the larger value of the lifetime gathered from the resource manager and the lifetime obtained from the solid state drive for the same RU as the lifetime of the same RU, and then compute and update the ERUGCTL for each RUH and the ESTDTL for each file level, which corresponds to operations S601 and S602 as shown in FIG. 6. This may refer to the relevant description above and will not be repeated here.

The compaction optimizer 2109 includes a compaction selector 21091 for providing a further optimized method of selecting compaction victims to reduce the write amplification effect on the FDP SSDs, which corresponds to the operation of determining the reclaim order in the garbage collection performed by the host side on the data file objects in operation S603 as shown in FIG. 6. This may refer to relevant description above. The operation of determining the recycling order in the garbage collection performed by the host side for the data file object in operation S603 as shown in FIG. 6 can be referred to the relevant introduction in the previous section, and will not be repeated here.

The GC 105 of the SSD 10 modifies the priority policy of victim selection for the GC 105 of the SSD 10 based on the ERUGCTL set by the host 20, which corresponds to the garbage collection performed by the SSD 10 on the recycling unit object in operation S603 as shown in FIG. 6. This may refer to description above, and which will not be repeated here.

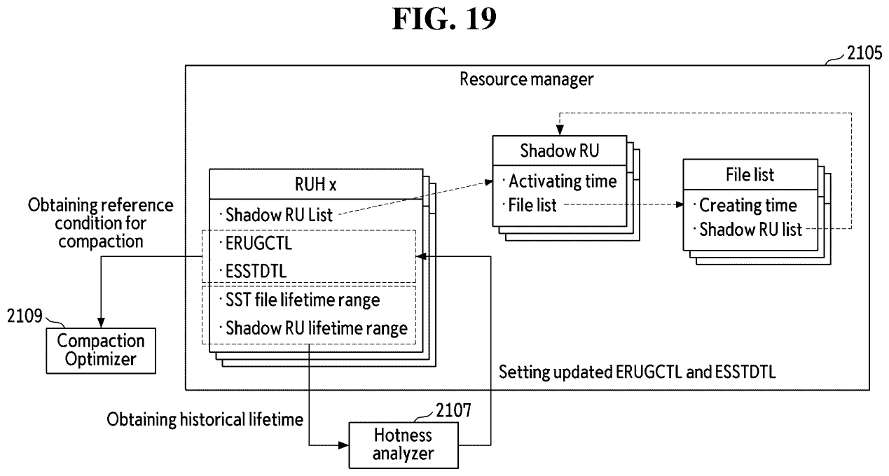

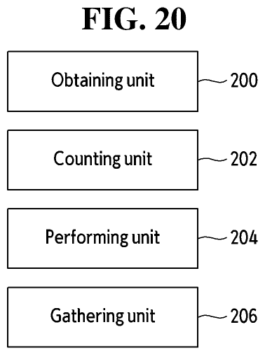

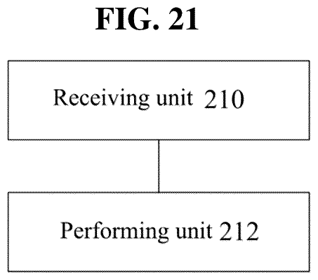

The garbage collection methods for a host side and a solid state drive according to some example embodiments of the present disclosure have been described with reference to FIGS. 6 to 19 above. In the following, garbage collection devices and units thereof for a host side and a solid state drive according to some example embodiments of the present disclosure will be described with reference to FIG. 20 and FIG. 21.

FIG. 20 illustrates a block diagram of a garbage collection device for a host side according to some example embodiments of the present disclosure. Referring to FIG. 20, the garbage collection device includes an obtaining unit 200, a counting unit 202, and a performing unit 204. The obtaining unit 200 is configured to obtain, for each of a plurality of target objects in a solid state drive connected to the host side, lifetimes of other objects related to the each target object in solid state drive as historical lifetimes of the each target object, wherein the plurality of target objects include at least one of a reclaim unit object and a data file object, and the reclaim unit object is a physical storage unit for storing the data file object in the solid state drive. The counting unit 202 is configured to count the historical lifetimes of the each target object to obtain a reference lifetime of the each target object, and the performing unit 204 is configured to perform garbage collection based on reference lifetimes of the plurality of target objects.

In some example embodiments of the present disclosure, the obtaining 200 is further configured to for the target object that is the reclaim unit, take a reclaim unit handle pointing to the target object as a target reclaim unit handle, obtain lifetimes of a plurality of historical reclaim units to which the target reclaim unit handle pointed as the historical lifetimes of the target object; for the target object that is the data file, take a file level in which the target object is located as a target file level, obtain lifetimes of a plurality of historical data files that existed in the target file level as the historical lifetimes of the target object.

In some example embodiments of the present disclosure, the obtaining unit 200 is further configured to obtain the lifetimes of the plurality of historical reclaim units to which the target reclaim unit handle pointed as historical lifetimes of all target objects to which the target reclaim unit handle points, and obtain the lifetimes of the plurality of historical data files that existed in the target file level as historical lifetimes of all target objects in the target file level.

In some example embodiments of the present disclosure, the counting unit 202 is further configured to count a value range of the historical lifetimes of the each target object, and determine a specified quartile of the value range as the reference lifetime of the each target object.

In some example embodiments of the present disclosure, the historical lifetimes are continuously updated over time, and the counting unit 202 is further configured to count the historical lifetimes of the each target object to obtain the reference lifetime of the each target object in a case that it is determined that a workload of the solid state drive has changed, at a preset cycle.

In some example embodiments of the present disclosure, the performing unit 204 is further configured to transmit the reference lifetime of the reclaim unit object of the plurality of target objects to the solid state drive to configure the reclaim unit object of the plurality of target objects as not to participate in garbage collection until the reference lifetime corresponding to the reclaim unit object expires.

In some example embodiments of the present disclosure, the garbage collection device further includes a gathering unit 206 configured to gather object information of each of objects in the solid state drive belonging to categories that are identical to that of the plurality of target objects, wherein the object information includes start-life-time, lifetime, and a storage relationship, wherein the start-life-time of the reclaim unit object is the time when the reclaim unit object is assigned to be used for writing a data file object, wherein the storage relationship of the reclaim unit object includes a data file object written into the reclaim unit object, the start-life-time of the data file object is creating time of the data file object, the storage relationship of the data file object includes a reclaim unit object into which the data file object is written.

In some example embodiments of the present disclosure, the performing unit 204 is further configured to determine, for a plurality of sets of data file objects on which the garbage collection is to be performed, a preset factor of each of the sets of data file objects according to the object information and the reference lifetimes involved in the each set of the data file objects, wherein the each set of data file objects includes a plurality of data file objects that are to be simultaneously reclaimed, and wherein the preset factor is used for reflecting a performance gain resulting from reclaiming the each set of data file objects; determine a reclaiming order of the plurality of sets of data file objects according to preset factors of the plurality of sets of data file objects; perform garbage collection on the plurality of sets of data file objects according to the reclaiming order.

In some example embodiments of the present disclosure, the preset factor includes at least one of a life factor of the data file object, a life factor of the reclaim unit object, a failure rate of the reclaim unit object, a file overlapping rate of the reclaim unit object, wherein the life factor of the data file object is determined by comparing survival duration with the reference lifetime of the data file object, the life factor of the reclaim unit object is determined by comparing usage duration with the reference lifetime of the reclaim unit object, the failure rate of the reclaim unit object is determined by comparing a capacity of invalid data on the reclaim unit object with a capacity of the reclaim unit object, the capacity of the invalid data includes a capacity of data file objects that have been deleted and a capacity of candidate data file objects written into the reclaim unit object, the candidate data file objects are data file objects belonging to the sets of data file objects, and the file overlapping rate of the reclaim unit object is determined by comparing the number of the candidate data file objects written into the reclaim unit object with the number of all data file objects written into the reclaim unit object.

FIG. 21 illustrates a block diagram of a garbage collection device for a solid state drive according to some example embodiments of the present disclosure. Referring to FIG. 21, the garbage collection device includes a receiving unit 210 and a performing unit 212. The receiving unit 210 is configured to receive a reference lifetime of a reclaim unit object transmitted by a host side connected to the solid state drive, wherein the reference lifetime of the reclaim unit object is obtained by counting historical lifetimes of the reclaim unit object, and the historical lifetimes include lifetimes of other objects in the solid state drive related to the reclaim unit object. The performing unit 212 is configured to perform garbage collection according to the received reference lifetime of the reclaim unit object.

In some example embodiments of the present disclosure, the performing unit 212 is further configured to exclude, during performing of the garbage collection, the reclaim unit object of which the reference lifetime has not expired.

In some example embodiments of the present disclosure, the receiving unit 210 is further configured to receive a reference lifetime of a reclaim unit handle transmitted by the host side, configuring the reference lifetime of the reclaim unit handle to be reference lifetimes of all reclaim unit objects to which the reclaim unit handle points.

It should be understood that methods and devices according to some example embodiments of the present disclosure may be implemented as a hardware component and/or software component. One of skill in the art may, for example, implement the respective unit/module using a field programmable gate array (FPGA) or an application-specific integrated circuit (ASIC), according to the processing performed by the respective unit/module being limited.

According to some example embodiments of the present disclosure, there is provided a computer-readable storage medium storing a computer program, wherein the computer program, when executed by a processor, implements the garbage collection method for the host side and the garbage collection method for the solid state drive as described in the present disclosure.

Specifically, the garbage collection method for the host side and the garbage collection method for the solid state drive according to some example embodiments of the present disclosure may be written as the computer program, code segments, instructions, or any combination thereof, and recorded, stored, or fixed in or on one or more non-transitory computer-readable storage medium. The computer-readable storage medium is any data storage device that can store data read out by a computer system. Examples of computer-readable storage medium include a read-only memory, a random access memory, a read-only CD-ROM, a magnetic tape, a floppy disk, an optical data storage device, and a carry (such as data transfer over the internet via wired or wireless transmission paths).

According to some example embodiments of the present disclosure, there is provided an electronic apparatus, wherein the electronic apparatus includes at least one processor; and at least one memory storing computer-executable instructions, wherein the computer-executable instructions, when executed by the at least one processor, cause the at least one processor to execute the garbage collection method for the host side and the garbage collection method for the solid state drive as described in the present disclosure.

Specifically, the electronic apparatus may be broadly defined as a tablet, a smartphone, a smartwatch, or any other electronic apparatus with the necessary computational and/or processing capability. In one embodiment, the electronic apparatus may include a processor, a memory, a network interface, a communication interface, etc. connected via a system bus. The processor of the electronic apparatus may be used to provide the necessary computing, processing, and/or control capability. The memory of the electronic apparatus may include a non-volatile storage medium and an internal memory. The non-volatile storage medium may have stored therein or thereon an operating system, computer programs, and the like. The internal memory may provide an environment for the operation of the operating system and the computer programs in the non-volatile storage medium. The network interface and the communication interface of the electronic apparatus may be used to connect and communicate with external apparatuses via a network.

According to some example embodiments of the present disclosure, there is provided computer program products, for example, stored in non-transitory memory, including computer instructions, the computer instructions when executed by a processor implement the garbage collection method for the host side and/or the garbage collection method for the solid state drive as described in the present disclosure.

Any or all of the elements described with reference to the figures may communicate with any or all other elements described with reference to figures. For example, any element may engage in one-way and/or two-way and/or broadcast communication with any or all other elements in the figures, to transfer and/or exchange and/or receive information such as but not limited to data and/or commands, in a manner such as in a serial and/or parallel manner, via a bus such as a wireless and/or a wired bus (not illustrated). The information may be in encoded various formats, such as in an analog format and/or in a digital format.

As described herein, any electronic devices and/or portions thereof according to any of the example embodiments may include, may be included in, and/or may be implemented by one or more instances of processing circuitry such as hardware including logic circuits; a hardware/software combination such as a processor executing software; or any combination thereof. For example, the processing circuitry more specifically may include, but is not limited to, a central processing unit (CPU), an arithmetic logic unit (ALU), a graphics processing unit (GPU), an application processor (AP), a digital signal processor (DSP), a microcomputer, a field programmable gate array (FPGA), and programmable logic unit, a microprocessor, application-specific integrated circuit (ASIC), a neural network processing unit (NPU), an Electronic Control Unit (ECU), an Image Signal Processor (ISP), and the like. In some example embodiments, the processing circuitry may include a non-transitory computer readable storage device (e.g., a memory), for example a DRAM device, storing a program of instructions, and a processor (e.g., CPU) configured to execute the program of instructions to implement the functionality and/or methods performed by some or all of any devices, systems, modules, units, controllers, circuits, architectures, and/or portions thereof according to any of the example embodiments, and/or any portions thereof.

As used herein, expressions such as “one of,” “one or more of,” “any one of,” “at least one of,” and “at least one selected from” when preceding a list of elements, modify the entire list of elements and do not modify the individual elements of the list. Thus, for example, both “at least one of A, B, or C” and “at least one of A, B, and C” mean either A, B, C, or any combination thereof. Likewise, A and/or B means A, B, or A and B. While the term “same,” “equal” or “identical” is used in description of example embodiments, it should be understood that some imprecisions may exist. Thus, when one element is referred to as being the same as another element, it should be understood that an element or a value is the same as another element within a desired manufacturing or operational tolerance range (e.g., ±10%).

According to some example embodiments of the present disclosure, there is provided a garbage collection system including a host device, and a storage device electrically connected to the host device, the storage device including a receiving unit configured to receive a reference lifetime of a reclaim unit object transmitted by the host device, the reference lifetime of the reclaim unit object is obtained by counting historical lifetimes of the reclaim unit object, the historical lifetimes include lifetimes of other objects in the solid state drive related to the reclaim unit object; and a performing unit configured to perform garbage collection according to the received reference lifetime of the reclaim unit object, the host device including an obtaining unit configured to obtain the lifetimes of the other objects related to each of target objects in the solid state drive as historical lifetimes of each of the target objects, the target objects include at least one of a reclaim unit object or a data file object, the reclaim unit object is a physical storage unit configured to store the data file object in the solid state drive; and a counting unit configured to count the historical lifetimes of each of the target objects to obtain a reference lifetime of each of the target objects.

According to some example embodiments of the present disclosure, there is provided the garbage collection system, wherein the performing unit is configured to perform the garbage collection based on instructions from the host device.

Although the present disclosure has been specifically shown and described with reference to some example embodiments thereof, it should be understood by those skilled in the art that various changes in form and detail may be made without departing from the spirit and scope of the present disclosure as defined by the claims.

1. A garbage collection method for a host side, the garbage collection method comprising:
obtaining, for each of target objects in a solid state drive connected to the host side, lifetimes of other objects related to each of the target objects in the solid state drive as historical lifetimes of each of the target objects, the target objects comprising at least one of a reclaim unit object or a data file object, the reclaim unit object being a physical storage unit configured to store the data file object in the solid state drive;
counting the historical lifetimes of each of the target objects to obtain a reference lifetime of each of the target objects; and
performing garbage collection based on reference lifetimes of the target objects.

2. The garbage collection method of claim 1, wherein the obtaining, for each of the target objects in the solid state drive connected to the host side, the lifetimes of the other objects related to each of the target objects in the solid state drive as the historical lifetimes of each of the target objects comprises
based on the target object including the reclaim unit, using a reclaim unit handle pointing to the target object as a target reclaim unit handle, and obtaining lifetimes of a plurality of historical reclaim units to which the target reclaim unit handle pointed as the historical lifetimes of the target object; and
based on the target object including the data file, using a file level in which the target object is located as a target file level, and obtaining lifetimes of a plurality of historical data files that existed in the target file level as the historical lifetimes of the target object.

3. The garbage collection method of claim 2, wherein the obtaining the lifetimes of the plurality of historical reclaim units to which the target reclaim unit handle pointed as the historical lifetimes of the target object comprises:
obtaining the lifetimes of the plurality of historical reclaim units to which the target reclaim unit handle pointed as historical lifetimes of all of the target objects to which the target reclaim unit handle points, and
the obtaining the lifetimes of the plurality of historical data files that existed in the target file level as the historical lifetimes of the target object comprises:
obtaining the lifetimes of the plurality of historical data files that existed in the target file level as historical lifetimes of all of the target objects in the target file level.

4. The garbage collection method of claim 1, wherein the counting the historical lifetimes of each of the target objects to obtain the reference lifetime of each of the target objects comprises:
counting a value range of the historical lifetimes of each of the target objects; and
determining a specified quartile of the value range as the reference lifetime of each of the target objects.

5. The garbage collection method of claim 1, wherein the historical lifetimes are continuously updated over time, and the counting the historical lifetimes of each of the target objects to obtain the reference lifetime of each of the target objects comprises:
counting the historical lifetimes of each of the target objects to obtain the reference lifetime of each of the target objects based on a determination that a workload of the solid state drive has changed, at a cycle.

6. The garbage collection method of claim 1, wherein the performing garbage collection based on the reference lifetimes of the target objects comprises:
transmitting the reference lifetime of the reclaim unit object of the target objects to the solid state drive to configure the reclaim unit object of the target objects as not to participate in the garbage collection until the reference lifetime corresponding to the reclaim unit object expires.

7. The garbage collection method of claim 1, the garbage collection method further comprises:
gathering object information of each of objects in the solid state drive belonging to categories that are identical to those of the target objects,
wherein the object information comprises start-life-time, lifetime, and a storage relationship,
wherein the start-life-time of the reclaim unit object is a time the reclaim unit object is assigned to be used for writing the data file object,
wherein the storage relationship of the reclaim unit object comprises the data file object written into the reclaim unit object, the start-life-time of the data file object is a creation time of the data file object, the storage relationship of the data file object comprises the reclaim unit object into which the data file object is written.

8. The garbage collection method of claim 7, wherein the performing garbage collection based on the reference lifetimes of the target objects comprises:
determining, for sets of data file objects on which the garbage collection is to be performed, a factor of each of the sets of data file objects according to the object information and the reference lifetimes involved in each of the sets of the data file objects, wherein each of the sets of the data file objects comprises a plurality of data file objects that are to be simultaneously reclaimed, and wherein the factor is based on a performance gain resulting from reclaiming each of the sets of the data file objects;
determining a reclaiming order of the sets of data file objects according to the factors of the sets of data file objects; and
performing the garbage collection on the sets of data file objects according to the reclaiming order.

9. The garbage collection method of claim 8, wherein
the factor comprises at least one of a life factor of the data file object, a life factor of the reclaim unit object, a failure rate of the reclaim unit object, or a file overlapping rate of the reclaim unit object,
the life factor of the data file object is determined by comparing survival duration with the reference lifetime of the data file object,
the life factor of the reclaim unit object is determined by comparing usage duration with the reference lifetime of the reclaim unit object,
the failure rate of the reclaim unit object is determined by comparing a capacity of invalid data on the reclaim unit object with a capacity of the reclaim unit object, the capacity of the invalid data comprises a capacity of data file objects that have been deleted and a capacity of candidate data file objects written into the reclaim unit object, and the candidate data file objects are data file objects belonging to the sets of data file objects, and
the file overlapping rate of the reclaim unit object is determined by comparing a number of the candidate data file objects written into the reclaim unit object with a number of all data file objects written into the reclaim unit object.

10. A garbage collection method for a solid state drive, the garbage collection method comprising:
receiving a reference lifetime of a reclaim unit object transmitted by a host side connected to the solid state drive, the reference lifetime of the reclaim unit object obtained by counting historical lifetimes of the reclaim unit object, the historical lifetimes comprise lifetimes of other objects in the solid state drive related to the reclaim unit object; and
performing garbage collection according to the received reference lifetime of the reclaim unit object.

11. The garbage collection method of claim 10, wherein the performing the garbage collection according to the received reference lifetime of the reclaim unit object comprises:
excluding, during performing of the garbage collection, the reclaim unit object of which the reference lifetime has not expired.

12. The garbage collection method of claim 10, wherein the receiving the reference lifetime of the reclaim unit object transmitted by the host side connected to the solid state drive comprises:
receiving a reference lifetime of a reclaim unit handle transmitted by the host side, and configuring the reference lifetime of the reclaim unit handle to be reference lifetimes of all reclaim unit objects to which the reclaim unit handle points.

13. A garbage collection device for a host side, the garbage collection device comprises:
an obtaining unit configured to obtain, for each of target objects in a solid state drive connected to the host side, lifetimes of other objects related to each of the target objects in the solid state drive as historical lifetimes of each of the target objects, the target objects comprise at least one of a reclaim unit object or a data file object, the reclaim unit object is a physical storage unit configured to store the data file object in the solid state drive;
a counting unit configured to count the historical lifetimes of each of the target objects to obtain a reference lifetime of each of the target objects; and
a performing unit configured to perform garbage collection based on reference lifetimes of the target objects.

14. The garbage collection device of claim 13, wherein the obtaining unit is further configured to:
based on the target object including the reclaim unit, use a reclaim unit handle pointing to the target object as a target reclaim unit handle, and obtain lifetimes of a plurality of historical reclaim units to which the target reclaim unit handle pointed as the historical lifetimes of the target object; and
based on the target object including the data file, use a file level in which the target object is located as a target file level, and obtain lifetimes of a plurality of historical data files that existed in the target file level as the historical lifetimes of the target object.

15. The garbage collection device of claim 14, wherein the obtaining unit is further configured to:
obtain the lifetimes of the plurality of historical reclaim units to which the target reclaim unit handle pointed as historical lifetimes of all of the target objects to which the target reclaim unit handle points; and
obtain the lifetimes of the plurality of historical data files that existed in the target file level as historical lifetimes of all of the target objects in the target file level.

16. The garbage collection device of claim 13, wherein the counting unit is further configured to:
count a value range of the historical lifetimes of each of the target objects; and
determine a specified quartile of the value range as the reference lifetime of each of the target objects.

17. The garbage collection device of claim 13, wherein
the historical lifetimes are continuously updated over time, and
the counting unit is further configured to count the historical lifetimes of each of the target objects to obtain the reference lifetime of each of the target objects based on a determination that a workload of the solid state drive has changed, at a cycle.

18. The garbage collection device of claim 13, wherein the performing unit is configured to transmit the reference lifetime of the reclaim unit object of the target objects to the solid state drive to configure the reclaim unit object of the target objects as not to participate in garbage collection until the reference lifetime corresponding to the reclaim unit object expires.

19. The garbage collection device of claim 13, the garbage collection device further comprising
a gathering unit configured to gather object information of each of objects in the solid state drive belonging to categories that are identical to those of the target objects,
wherein the object information comprises start-life-time, lifetime, and a storage relationship,
wherein the start-life-time of the reclaim unit object is a time the reclaim unit object is assigned to be used for writing the data file object,
wherein the storage relationship of the reclaim unit object comprises the data file object written into the reclaim unit object, the start-life-time of the data file object is a creation time of the data file object, and the storage relationship of the data file object comprises the reclaim unit object into which the data file object is written.

20. The garbage collection device of claim 19, wherein the performing unit is further configured to:
determine, for sets of data file objects on which the garbage collection is to be performed, a factor of each of the sets of data file objects according to the object information and the reference lifetimes involved in each of the sets of the data file objects, wherein each of the sets of data file objects comprises data file objects to be simultaneously reclaimed, and wherein the factor is based on a performance gain resulting from reclaiming each of the sets of data file objects;
determine a reclaiming order of the sets of data file objects according to the factors of the sets of data file objects; and
perform the garbage collection on the sets of data file objects according to the reclaiming order.

21. (canceled)

22. (canceled)

23. (canceled)

24. (canceled)

25. (canceled)

26. (canceled)
